(19) United States
(12) Patent Application Publication
(10) Pub. No.: US 2026/0346581 A1
(43) Pub. Date: Nov. 5, 2026

(54) Thermal Barrier Article for a Rechargeable Electrical Energy Storage System

(71) Applicant: 3M INNOVATIVE PROPERTIES COMPANY, St. Paul, MN (US)

(72) Inventors: Walter R. Romanko, Austin, TX (US); Morgan A. Priolo, Georgetown, TX (US); Junkang J. Liu, Woodbury, MN (US); Mitchell T. Huang, Austin, TX (US); Christoph Kuesters, Korschenbroich (DE); Dinh Ba Le, St. Paul, MN (US); Daniel S. Bates, Chisago City, MN (US); Mark A. Fairbanks, Lino Lakes, MN (US)

(21) Appl. No.: 19/478,387

(22) PCT Filed: May 2, 2024
(86) PCT No.: PCT/IB2024/054249

§ 371 Date: Oct. 24, 2025

Related U.S. Application Data
(60) Provisional application No. 63/500,015, filed on May 4, 2023.

(51) Int. Cl. B32B 18/00; B32B 5/24; B32B 7/027; B32B 7/12; H01M 10/658

(52) U.S. Cl. CPC B32B 18/00; B32B 5/24; B32B 7/027; B32B 7/12; H01M 10/658; B32B 2250/03; B32B 2255/02; B32B 2255/20; B32B 2262/101; B32B 2262/105; B32B 2307/102; B32B 2307/7376; B32B 2457/10; B32B 2571/00; H01M 2220/20

(57) ABSTRACT

A thermal barrier article comprises a multilayer material that includes a first fabric layer disposed on a first side of a ceramic layer and a second fabric layer disposed on an opposite side of the ceramic layer. The thermal barrier article can also comprise an alternating arrangement of a plurality of fabric layers and ceramic layers. In each of these aspects, the thermal barrier article has sufficient flexure and thermal properties to withstand a flexural conditioning test and a pyrotechnic blast test that has a temperature of at least 1200 °C and expels a non-insubstantial amount of particulate.

### FIELD

The invention relates to the use of a multilayer material as a barrier article in a rechargeable electrical energy storage system comprising for example a plurality of single rechargeable battery cells or battery cell modules or battery cell module packs.

The present invention also relates to electric vehicle batteries and particularly to blast resistant and thermally insulating barrier articles for managing battery cell/module/pack thermal runaway incidents. The provided articles can be especially useful, for example, in automotive, aircraft, watercraft, and stationary energy storage applications.

### BACKGROUND

Rechargeable or reloadable batteries or rechargeable electrical energy storage systems comprising a number of single battery cells, such as for example lithium-ion cells, are known and used in several fields of technique, including e.g., as electric power supply of mobile phones and portable computers or electric cars or vehicles or hybrid cars.

It is also known that rechargeable battery cells, such as lithium-ion cells, sometimes undergo internal overheating caused by events such as short circuits within the cell, improper cell use, manufacturing defects or exposure to extreme external temperature. This internal overheating can lead to a so called “thermal runaway” when the reaction rate within the cell caused by the high temperature increases to a point where more heat is generated within the cell than can be withdrawn and the generated heat leads to a further increase of the reaction rate and in turn of the generated heat. In standard lithium-ion (Li-ion) battery configurations, for example, the heat generated within such defective cells can reach 500 °C to 1000 °C, in localized hot spots even more.

The next generation of electrical vehicle EV batteries will be higher energy than batteries used today. High energy batteries such as those described as 811 (NMC, or nickel—manganese—cobalt ratio) or similar energy density can fail catastrophically if punctured or overheated. When this occurs, the ensuing battery fire will not only reach temperatures of 1200 °C or above but may also expel shrapnel at moderately high velocities. While battery packs are generally encased in an aluminum shell, aluminum melts at 660 °C, so the shell must be protected from the flame and shrapnel of a failed battery to allow occupants of the electrical vehicle time to exit in the event of such a failure. Battery packs can also be encased in fiber-reinforced polymeric composites, which, like aluminum, can also be breached at elevated temperatures.

While some materials exist that can survive a high temperature flame (i.e., greater than 1200 °C flame for tens of minutes with no breach), these materials cannot withstand the blast associated with a high energy battery thermal runaway event. Severe risks posed by thermal runaway propagation requires design of the battery module that features blast resistant and thermally insulating barriers to mitigate the effects of such a thermal runaway and provide time for vehicle occupants to safely vacate in the event of a fire.

### SUMMARY OF THE INVENTION

In view of the above, there is still a need for suitable materials and suitable arrangements that help to provide thermal insulation and that help to prevent or mitigate damage to adjacent materials and regions from blast particles emanating from a malfunctioning battery pack. There is also a need for such suitable materials that are easy to use in an assembly process and that provide flexibility with designing a rechargeable electrical energy storage system.

The present invention provides a thermal barrier article comprising a multilayer material. The multilayer material includes a first fabric layer disposed on a first side of a ceramic layer (also referred to herein as a ceramic-based binder layer) and a second fabric layer disposed on an opposite side of the ceramic layer. In yet another aspect, the barrier article can comprise an alternating arrangement of a plurality of fabric layers and ceramic layers. In each of these aspects, the barrier article has sufficient flexure and thermal properties to withstand both a flexure conditioning test and a pyrotechnic blast test. The flexure conditioning test is defined herein and simulates a manufacturing process that includes multiple turns about rolls or cylinders on a production line. The pyrotechnic test, also defined herein, subjects the thermal barrier article to a gerb blast having a temperature of at least 1200 °C that expels a non-insubstantial amount of particulate. The thermal barrier article can withstand the pyrotechnic blast test for at least 2.5 seconds.

In a first aspect, the at least one fabric layer includes a woven or nonwoven fiber mat or fabric. In another aspect, the fabric layer comprises inorganic fibers.

In another aspect, the ceramic layer comprises an inorganic filler and an inorganic binder.

In another aspect, the inorganic filler can comprise kaolin clay, metakaolin, talc, mica, mullite, phlogopite, muscovite, montmorillonite, smectite, bentonite, illite, chlorite, sepiolite, attapulgite, halloysite, vermiculite, laponite, rectorite, perlite, fly ash, fumed silica, silica fume, Portland cement, or concrete mixes.

In an aspect, the inorganic binder can comprise sodium silicate, potassium silicate, lithium silicate, calcium silicate, colloidal silica, water, and other similar materials used to bond inorganic fillers together.

In another aspect, the ceramic layer can further comprise a low concentration of chopped organic fibers such as PVA, polypropylene, polyolefin blends or copolymers, nylon, and blends thereof.

In other aspects, the fabric layers of the multilayer material can be the same throughout the multilayer material in at least one of composition and thickness. In another aspect, the fabric layers of the multilayer material can comprise different materials in some or all of the plurality of fabric layers and/or can be of different thicknesses.

In another aspect, the ceramic layers of the multilayer material can be the same throughout the multilayer material in at least one of composition and thickness. In another aspect, the ceramic layers of the multilayer material can comprise different materials in some or all of the plurality of ceramic layers and/or can be of different thicknesses.

In another aspect, at least one fabric layer comprises a woven or nonwoven fiber mat or fabric comprising a plurality of fibers selected from the group consisting of A-glass, C-glass, D-glass, E-glass, M-glass, R-glass, S-glass, ECR-glass, AR-glass, basalt fibers, silicate fibers (e.g. Astroquartz fibers), silicon carbide fibers, ceramic fibers (e.g. Nextel fibers), or other inorganic fibers.

In another aspect, at least one fabric layer comprises ceramic or mineral compositions such as basalt, alumina, aluminoborosilicate, Nextel, silicon carbide, quartz, and combinations thereof.

In another aspect, at least one fabric layer comprises a coating having an alkali-resistant composition. In another aspect, the alkali-resistant composition comprises calcium silicate.

In another aspect, the barrier article further comprises an adhesive layer applied to at least one outer surface of a fabric layer. In another aspect, the adhesive layer comprises one of a thermoset, a b-stage adhesive, a hot melt, a pressure-sensitive adhesive, a solvent-born adhesive, or a water-born adhesive.

In another aspect, the thermal barrier article has a Pyrotechnic Withstand Efficiency value of at least 5 and is operatively adapted to survive or withstand extremely high temperatures of at least 1200 °C (and/or much greater than 1200 °C) and substantial blast particle impact for an extended period of time.

In another aspect, the present invention provides a battery compartment of an electric vehicle comprising at least one battery cell or assembly and the thermal barrier article described above.

In another aspect, a method of preventing or at least mitigating the further spread of blast debris in or from an electric vehicle battery assembly comprises providing at least one battery cell of an electric vehicle battery assembly with the thermal barrier article described above.

Protecting against the dangers associated with a sudden thermal runaway event in an electric vehicle battery is a significant technical challenge.

Embodiments of the present invention address the challenges with conventional materials by providing a blast and thermal resistant barrier article that combines a relatively thin and flexible multilayer material. The structures can include a multilayer material comprising at least one fabric layer and at least one ceramic layer, with an adhesive layer disposed on an outer surface of the fabric layer (opposite the ceramic layer), a multilayer material comprising first and second fabric layers disposed on either side of a ceramic layer, or a multilayer material comprising multiple fabric and ceramic layers arranged in an alternating manner. Each fabric layer can comprise a woven or non-woven fibrous mat or fabric comprising inorganic fibers and each ceramic layer can comprise an inorganic filler and an inorganic binder. The flexible structures herein provide a blast and thermal barrier article that is operatively adapted to survive or withstand a pyrotechnic blast test for at least 2.5 seconds, where the blast has a temperature much greater than 1200 °C and expels a non-insubstantial amount of particulate.

### BRIEF DESCRIPTION OF THE DRAWINGS

The invention will now be described in more detail with reference to the following figures exemplifying particular embodiments of the invention:

FIGS. 1A, 1B, 1C, and 1D are schematic cross section views of exemplary barrier articles according to aspects of the invention.

FIG. 2 is a schematic view of an exemplary battery compartment of an electric vehicle.

FIG. 3 is a probability plot of the difference from the average for the eleven not-bent, not-flexed sample constructions (“As-Is” constructions) and the eleven bent or flexed sample constructions (“Bend-Flex” constructions).

Repeated use of reference characters in the specification and drawings is intended to represent the same or analogous features or elements of the disclosure. It should be understood that numerous other modifications and embodiments can be devised by those skilled in the art, which fall within the scope of the disclosure. The figures may not be drawn to scale.

### DETAILED DESCRIPTION

As used herein, the term “operatively adapted” refers to a structure that is designed, configured and/or dimensioned to perform the identified operation or performance.

As used herein, the terms “preferred” and “preferably” refer to embodiments described herein that can afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the invention.

As used herein and in the appended claims, the singular forms “a,” “an,” and “the” include plural referents unless the context clearly dictates otherwise. Thus, for example, reference to “a” or “the” component may include one or more of the components and equivalents thereof known to those skilled in the art. Further, the term “and/or” means one or all of the listed elements or a combination of any two or more of the listed elements.

It is noted that the term “comprises”, and variations thereof, do not have a limiting meaning where these terms appear in the accompanying description. Moreover, “a,” “an,” “the,” “at least one,” and “one or more” are used interchangeably herein. Relative terms such as left, right, forward, rearward, top, bottom, side, upper, lower, horizontal, and vertical may be used herein and, if so, are from the perspective observed in the particular figure. These terms are used only to simplify the description, however, and not to limit the scope of the invention in any way.

Reference throughout this specification to “one embodiment,” “certain embodiments,” “one or more embodiments” or “an embodiment” means that a particular feature, structure, material, or characteristic described in connection with the embodiment is included in at least one embodiment of the invention. Thus, the appearances of the phrases such as “in one or more embodiments,” “in certain embodiments,” “in one embodiment” or “in an embodiment” in various places throughout this specification are not necessarily referring to the same embodiment of the invention.

According to an embodiment of the invention, a thermal barrier article, also referred to as simply a barrier article, comprises a multilayer material that includes at least one fabric layer and at least one ceramic layer. Optionally, an adhesive can be applied to the fabric layer (opposite the ceramic layer). In another aspect, the barrier article can comprise a first fabric layer disposed on a first side of a ceramic layer (also referred to herein as a ceramic-based binder layer) and a second fabric layer disposed on an opposite side of the ceramic layer. In yet another aspect, the barrier article can comprise an alternating arrangement of a plurality of fabric layers and ceramic layers. In each of these aspects, the barrier article has sufficient flexure to withstand a flexure conditioning test and sufficient thermal barrier properties to withstand a pyrotechnic blast test.

The flexure conditioning test is defined herein below and simulates a manufacturing process that includes multiple turns about rolls or cylinders on a production line. The pyrotechnic blast test or pyrotechnic test, also defined herein below, subjects the thermal barrier article to a gerb blast having a temperature of at least 1200 °C, and/or much greater than 1200 °C, that expels a non-insubstantial amount of particulate. The thermal barrier article can withstand the pyrotechnic blast test for at least 2.5 seconds in a very thin construction, and at least 6 seconds in thicker constructions.

The multilayer material construction has a relatively high robustness and resiliency so it can be processed and safely handled in a manufacturing environment in a straightforward way, without compromising the material's blast resistance.

In a first aspect, the fabric layer comprises a woven or non-woven fibrous mat or fabric, where the woven or non-woven fibrous mat or fabric comprises inorganic fibers. In addition, the ceramic layer comprises an inorganic filler and an inorganic binder.

The multilayer material according to the invention may for example be used to ensure the overall safety of vehicles equipped with a rechargeable electrical energy storage system. The multilayer material may comprise at least three layers in an alternating material composition. When applied in an electric or hybrid vehicle, the alternating materials should have a suitable total thickness to accommodate a potentially constrained deployment space, while still providing sufficient thermal properties and blast resistance.

The multilayer material according to embodiments of the invention may be relatively thin (approximately 1.5 mm or less), although the overall thickness could be adjusted to a greater thickness depending on the specific application. The multilayer material may also be relatively lightweight (approximately 2000-3000 grams/sqm) but a higher or lower weight can be utilized, depending on the specific application and/or requirements.

To more safely enclose a battery pack in the event of a thermal runaway, the lid of a battery housing should be protected from the flame and shrapnel of a failed battery with a flame and blast-resistant lining, sometimes referred to as an “under-lid” material.

A suitable material used as a thermal insulation barrier should withstand high temperatures and high pressures accompanied by gas venting and particle blow without getting too damaged. In addition, the material needs to provide thermal and electrical insulation properties even during and after the high temperature, pressure and gas and/or particle impact.

The multilayer material according to the invention may be flexible, semi-flexible, or bendable without compromising blast or blast impact resistance. By “flexible” it is meant that the multilayer material is resilient and robust enough to withstand the Flexural Conditioning test described herein. Flexibility of the multilayer material ensures that the multilayer material has sufficient flexure to withstand a manufacturing process that includes multiple turns about rolls or cylinders on a production line. This manufacturability enables a broader use and a more effective application of the material, as the material's flexibility allows bending of the material to provide more options of applying it within a rechargeable electrical energy storage system.

The multilayer material according to the invention may comprise an inorganic fabric which comprises A-glass, C-glass, D-glass, E-glass, M-glass, R-glass, S-glass, ECR-glass, AR-glass, basalt fibers, silicate fibers (Astroquartz fibers), silicon carbide fibers, ceramic fibers (e.g. Nextel fibers), other inorganic fibers or a combination thereof. The fibers may be chemically treated. The inorganic fabric may for example be a single layer cloth, knitted fabric, interlaced fabric, and crocheted fabric or multilayer fabrics comprising woven or nonwoven layers bonded together by stitching, mechanical entanglement, or inorganic adhesives, or a combination thereof.

In another embodiment, while a fabric layer may include a woven or non-woven mat of fibrous material, as described above, another of the fabric layers may include inorganic particles or inorganic fibers such as an inorganic paper or an inorganic board. This layer may for example comprise an inorganic insulating paper comprising glass fibers and microfibers, such as 3M CEQUIN, commercially available from 3M Company, St. Paul, Minn., USA.

In another embodiment, at least one fabric layer can be formed from a multilayer construction that is mechanically bonded, such as through stitching or needle punching.

Each fabric layer may for example comprise a thickness in the range of 0.04 to 1.5 mm, for example 0.1 to 0.6 mm. It may also comprise a weight of 35 to 1,500 g/m² (gsm). The diameter of the individual filaments may range from about 4 to about 13 microns. The number of filaments per yarn can vary from about 5 to 1000. Typical weave patterns can include plain, basket, twill, leno, four-harness satin, eight-harness satin, and others typical in the industry. The warp and weft yarns can be the same or of different make-up.

In some embodiments, the ceramic layer comprises an inorganic binder and one or more fillers or additives. For example, the fillers can include inorganic materials such as kaolin clay, metakaolin, talc, mica, mullite, phlogopite, muscovite, montmorillonite, smectite, bentonite, illite, chlorite, sepiolite, attapulgite, halloysite, vermiculite, laponite, rectorite, perlite, fly ash, fumed silica, silica fume, Portland cement, concrete mixes, and combinations thereof. The form of the filler can include bead, solid particle, ground powder, flake, needle, rod, chopped fiber, hollow sphere, hollow tube, and the combination thereof.

The examples of clay or aluminosilicate include, but are not limited to: kaolin clay, talc, mica, wollastonite, montmorillonite, smectite, bentonite, illite, chlorite, sepiolite, attapulgite, halloysite, laponite, rectorite, perlite, and combinations thereof. Suitable types of kaolin clay include, but are not limited to, water-washed kaolin clay, delaminated kaolin clay, calcined kaolin clay, and surface-treated kaolin clay.

The examples of minerals include, but are not limited to calcite, aragonite, limestone, quartz, sphalerite, colemanite, ferberite, fluorite, gypsum, rutile, and apatite.

Optionally, a rheology modifier, an endothermic filler, and mixtures thereof, such as alumina trihydrate, magnesium hydroxide can be added.

The inorganic binder may comprise sodium silicate, potassium silicate, lithium silicate, calcium silicate, colloidal silica, (poly)phosphate, (poly)boronite, (poly)aluminate, water, and combinations thereof.

Optionally, additional organic materials can be added to the ceramic layer composition, such as glycerol, polyurethane, polyvinyl alcohol(s), styrene-butadiene, polystyrene, neoprene, polyvinyl chloride, polyvinyl acetate, acrylonitrile copolymers, acrylic polymers and copolymers, and carbohydrate (e.g., sugar(s)). These additional organic materials can be added in relatively small amounts of 5 wt. % or less.

In some embodiments, the ceramic layer, or each ceramic layer, of the multilayer material can comprise a thickness from about 0.2 mm to about 1.5 mm.

The total thickness of the multilayer material may be between 0.5 and 5 mm. In some applications where thinner materials are used, the total thickness of the multilayer material may be between 0.7 and 2 mm. It is possible to adjust the thickness of the material depending on the application the material is used in. As already stated above, the material may be flexible to improve the ease of applying the material in an assembly process, and to aid in withstanding shock and vibration in an automotive or other environment.

In another embodiment, the ceramic layer can further comprise chopped inorganic fibers or organic fibers, at a concentration of about 0.2 to about 3 wt. %.

As is apparent given the description herein, when utilizing a plurality of ceramic layers, each of the ceramic layers can have the same or different compositions, and/or can have the same or different thicknesses.

In one embodiment, the multilayer material can be formed by first blending the inorganic binder(s), inorganic filler(s), optional chopped organic fibers, and optional additives. This blend is coated between two or more fabric layers using techniques such as die coating onto one fabric layer and laying the second fabric on top. The coating can be dispensed onto one fabric layer and squeezed between two fabric layers in a calendar or nip, or other techniques. During formation of the multilayer material, some amount of binder and/or filler from the ceramic layer may infiltrate into one or both surrounding fabric layers. The ceramic layer can be cured or dried in an oven or other suitable device. Optionally, an adhesive may be applied to one or both sides.

In an alternative aspect, optionally, the barrier article can further comprise an adhesive layer applied to at least one outer surface of a fabric layer. The adhesive layer can comprise one of a thermoset, a b-stage adhesive, a hot melt, a pressure-sensitive adhesive, a solvent-born adhesive, or a water-born adhesive.

In an alternative aspect, one or more of the fabric layers can be in the form of a tape having an adhesive layer (e.g., a pressure sensitive adhesive layer) already disposed on the fabric layer material.

In one preferred embodiment, a plurality of fabric layers each comprise a woven or nonwoven glass fiber mat or fabric, and wherein at least one ceramic layer comprises an inorganic filler and an inorganic binder.

An embodiment of the invention also relates to a rechargeable electrical energy storage system with at least one battery cell and a barrier article such as described above.

An embodiment of the multilayer material according to the invention may for example be used to as a barrier article that helps increase the overall safety of vehicles equipped with a rechargeable electrical energy storage system.

The multilayer material may be arranged in a rechargeable electrical energy storage system such that a fabric layer faces the at least one battery cell/pack/module. The fabric layer is selected such that it has a high resistance towards temperature and other impacts, as might occur during a thermal runaway event.

The rechargeable electrical energy storage system according to the invention may provide a thermal barrier article which is positioned between the at least one battery cell and a lid of the storage system. The thermal barrier article may for example be fixed to the lid. Or it may be placed between the battery cells and the lid. The thermal barrier article may in such a position be used as a thermal insulation barrier for the lid or to protect the lid and any systems or components that are arranged adjacent to the lid. It may also be used as a thermal insulation barrier for any electrical components around the battery cells or battery packs such as for example cables or bus bars. When the thermal barrier article provides additional electrically insulating properties, short circuits for example due to deformation or other harm, can also be mitigated/prevented. Another possibility is to arrange the thermal barrier article such that it covers a burst plate of the at least one battery cell. Of course, the thermal barrier article can also be positioned in a rechargeable electrical energy storage system such that it fulfills all of the above-mentioned requirements. As already stated above, it may be advantageous to position the thermal barrier article such that the fabric layer faces towards the at least one battery cell, and, in particular, the fabric layer faces towards the burst plate of the battery cell.

Also, the use of the barrier article according to the invention is not limited to the use in a specific kind of rechargeable electrical energy storage systems. It may for example be used in rechargeable electrical energy storage system comprising prismatic battery cells, pouch cells, or cylindrical cells.

Also, the use of the barrier article according to the invention is not limited to the use in a specific kind of vehicle.

Herein below various embodiments of the present invention are described and shown in the drawings wherein like elements are provided with the same reference numbers.

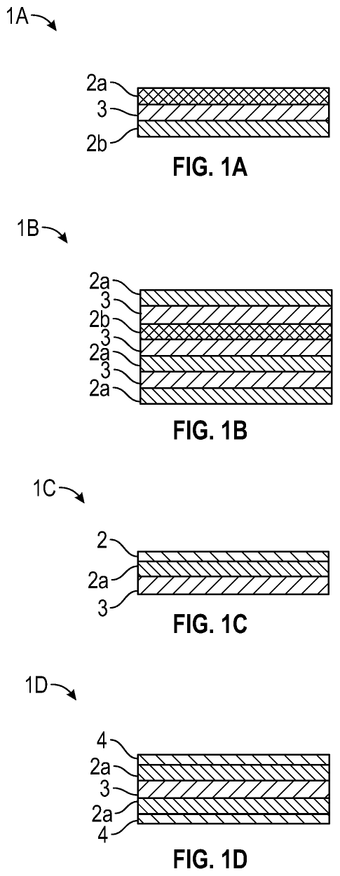

FIGS. 1A, 1B, 1C, and 1D are schematic cross section views of exemplary barrier articles according to aspects of the invention.

In FIG. 1A a cross-sectional view of a barrier article 1A according to one embodiment of the invention is displayed. The barrier article 1A of FIG. 1A comprises first and second fabric layers 2a and 2b and a ceramic layer 3. The fabric layers and ceramic layer can have compositions such as described previously. In this example, first fabric layer 2a has a different composition and/or thickness than second fabric layer 2b. Of course, in other embodiments, first fabric layer 2a can have the same composition and thickness as second fabric layer 2b. In other embodiments, such as shown in FIG. 1B, a barrier article 1B can comprise alternating layers of fabric layers and ceramic layers. In this example, barrier article 1B includes 4 fabric layers (2a, 2b, 2a, 2b) and 3 ceramic layers 3. Accordingly, in other embodiments of the invention, the barrier articles can comprise 2, 3, 4, 5, 6, 7, 8, 9, 10 (or more) fabric layers with 2, 3, 4, 5, 6, 7, 8, 9 (or more) ceramic layers.

FIG. 1C shows a cross-sectional view of a barrier article 1C according to another embodiment of the invention. In this example, a ceramic layer 3 is disposed on a first side of fabric layer 2a. The fabric layer and ceramic layer can have compositions such as described previously. On a second (opposite) side, or outer surface, of fabric layer 2a, an adhesive layer 4 is disposed. The adhesive layer can have a composition such as described previously. In an alternative embodiment, the adhesive layer 4 can be disposed on the ceramic layer 3 opposite the fabric layer 2a. In other embodiments, such as shown in FIG. 1D, a barrier article 1D can comprise first and second fabric layers 2a and ceramic layer 3 disposed between the first and second fabric layers, with outer surfaces of the first and second fabric layers each having an adhesive layer 4 disposed thereon. In other embodiments of the invention, the barrier articles can comprise 2, 3, 4, 5, 6, 7, 8, 9, 10 (or more) fabric layers with 2, 3, 4, 5, 6, 7, 8, 9 (or more) ceramic layers.

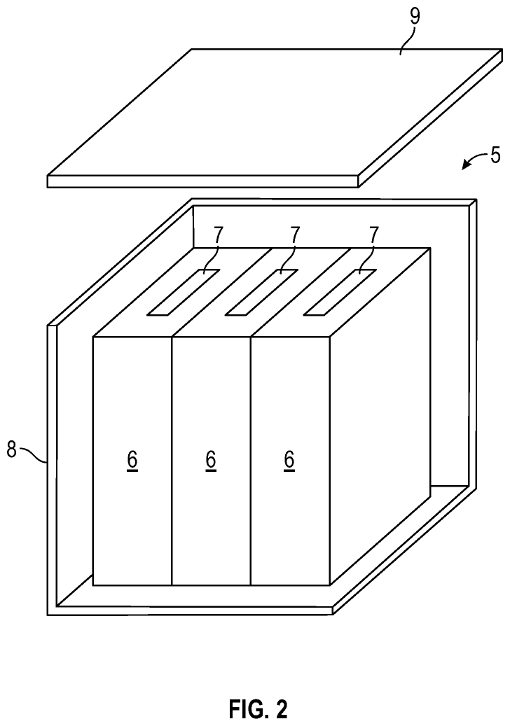

FIG. 2 is a schematic drawing of a rechargeable electrical energy storage system 5. The system comprises prismatic battery cells 6. The prismatic battery cells 6 each comprise a burst plate 7 to release potentially generated excessive pressure through a venting hole, for example in case of a thermal runaway event. The cells 6 are arranged in a housing 8 (which is shown with two open walls—one front wall and one side wall—that are closed in reality). The housing provides a lid 9.

As already described above regulations require that a rechargeable energy storage system is built in a way that no external fire occurs. One area that needs to be protected is the area above the burst plates 7. Parts of the system that are arranged over the burst plate need a thermal barrier in order to avoid a burn-through of the battery and open flames outside of the system. According to the invention a barrier article, such as any of the barrier articles shown in FIGS. 1A-1D, is disposed between battery cells 6/burst plates 7 and the lid 9.

The multilayer materials 1a-1d may also be placed between the cells 6 and the side walls or the bottom wall of the housing 8 (not shown).

The blast resistant and thermally insulating barrier articles described herein, in some embodiments, can be effective in mitigating the effects of thermal runaway propagation in Li-Ion batteries. These articles can also have potential uses in other commercial and industrial applications, such as automotive, electrified transportation, residential, industrial, watercraft, and aerospace applications, where it is necessary to protect people or surrounding structures from the effects of flying debris or thermal fluctuations. For example, the blast resistant and thermally insulating barrier articles can be incorporated into primary structures extending along or around transportation or building compartmental structures to protect users and occupants. Such applications can include protection around battery modules, fuel tanks, and any other enclosures or compartments.

Further components, configurations thereof, and test methods are described in the sub-sections that follow.

Further, the particle size of the inorganic filler particles in the binder layer may only be limited by ceramic layer thickness. Typically, the inorganic filler particles have a maximum particle size of about 8000 microns (μm) in at least one dimension. More typically, the inorganic filler particles have a particle size ranging from about 0.1 μm to about 2000 μm in at least one dimension. Even more typically, the inorganic filler particles have a particle size ranging from about 0.2 μm to about 50 μm in at least one dimension.

These layers, and successive layers, are shown flatly contacting each other in FIGS. 1A-1D. However, it is to be understood that the layers of the barrier articles 1A-1D are flexible and the contacting areas between layers may not be planar or even continuous.

The barrier articles 1a-1d of FIGS. 1A-1D can be disposed in one or more locations in an electric vehicle battery module. Typically, a plurality of battery cells is structurally aligned and secured within a battery compartment. The battery cells can be any shape (e.g., cylindrical or rectangular) or size. Gaps are generally present between each of the battery cells and/or between the battery cells and the walls of the battery compartment. The barrier articles can be secured to the compartment lid or disposed on the walls of the battery compartment.

### EXPERIMENTS AND EXAMPLES

TABLE 1
Test Materials

| Material | Description |
|---|---|
| 3M ™ Adhesive Transfer Tape 91022 (3M | silicone pressure sensitive adhesive transfer tape, |
| Co., mmm.com) | 0.05 mm thick |
| Aluminum sheet/plate | 5052 aluminum, nominal 1.27 mm thick |
| 304 Stainless Steel (McMaster-Carr, | 304 stainless steel, 0.75, 1.61, and 2.24 mm |
| mcmaster.com) | (nominal thicknesses were 0.03, 0.06, 0.09 inches) |
| 1162 (JPS Composite Materials, jpscm.com) | e-glass cloth, 0.14 mm thick, 137 g/sqm |
| 1597 (JPS Composite Materials, jpscm.com) | e-glass cloth, 0.97 mm thick, 1308 g/sqm |
| PW-200-13-100 (Sudaglass, sudaglass.com) | plain weave basalt fabric, 200 g/sqm |
| PW-350-13-100 (Sudaglass, sudaglass.com) | plain weave basalt fabric, 350 g/sqm |
| SC2025 (Unitex Composite, | Texturized e-glass cloth, calcium silicate coated, |
| unitexcomposite.com) | 0.80 mm thick, 660 g/sqm |
| TG430, calcium silicate coated (HKO, | e-glass cloth, calcium silicate coated, 0.38 mm |
| hko.de) | thick, 430 g/sqm |
| K Sodium Silicate ® (PQ Corp, pqcorp.com) | aqueous solution of 11.0% Na₂O, 31.7% SiO₂ |
| KASIL ® 1 (PQ Corp, pqcorp.com) | aqueous solution of 8.3% K₂O, 20.8% SiO₂ |
| KASIL ® 6 (PQ Corp, pqcorp.com) | aqueous solution of 12.7% K₂O, 26.5% SiO₂ |
| CFP 012 (3M.com) | Boron nitride flake, d50 8-14 μm |
| Fused Silica 550 (3M.com) | 3.5-5.2 μm average particle size |
| Mattex Pro (BASF, basf.com) | calcined kaolin |
| Polyplate P01 (KaMin LLC, kaminllc.com) | kaolin |
| Satintone SP33 (BASF, basf.com) | calcined kaolin |
| Suzorite 20-S (Imerys S.A., imerys.com) | phlogopite mica |
| Nextel 720, chopped fiber (3M.com) | chopped ceramic fiber, 6.4 mm length |
| Nycon RC (Nycon Corporation, nycon.com) | chopped nylon fiber, 9 μm diameter, 3 mm length |
| Pyrotechnic gerb (RES Pyro, respyro.com) | 20 second duration, 15 foot (4.6 meter) high, silver |
| | color |

Seven ceramic formulations were utilized in the examples:
Ceramic Formulation A: 63.5% Kasil 6+0.8% deionized water+35.7% Polyplate P01
Ceramic Formulation B: 59.5% Kasil 6+2.0% deionized water+38.5% Polyplate P01
Ceramic Formulation C: 52.0% Kasil 1+31.0% Satintone SP33+17.0% Suzorite 20S
Ceramic Formulation D: 48.0% Kasil 1+12.0% K Sodium Silicate+40.0% Polyplate P01
Ceramic Formulation E: 60.0% Kasil 6+20.0% CFP 012+20.0% Fused Silica 550
Ceramic Formulation F: 78.8% K Sodium Silicate+0.2% Nextel 720 chopped fiber+11.0%
Mattex Pro+10.0% Suzorite 20S
Ceramic Formulation G: 61.0% Kasil 6+4.0% Nycon RC+35.0% Mattex Pro

TABLE 2
Weight percent for each component in
the ceramic formulations after drying

| | Dry Weight Percent for each Ceramic Formulation | | | | | | |
|---|---|---|---|---|---|---|---|
| Component | A | B | C | D | E | F | G |
| Kasil 6 | 41.1 | 37.7 | | | 37.0 | | 38.0 |
| Kasil 1 | | | 24.0 | 23.6 | | | |
| K Sodium Silicate | | | | 8.7 | | 61.3 | |
| Polyplate P01 | 58.9 | 62.3 | | 67.7 | | | |
| Satintone SP33 | | | 49.1 | | | | |
| Suzorite 20S | | | 26.9 | | | 18.2 | |
| CFP 012 | | | | | 31.5 | | |
| Fused Silica 550 | | | | | 31.5 | | |
| Mattex Pro | | | | | | 20.1 | 55.6 |
| Nextel 720 | | | | | | 0.4 | |
| Nycon RC | | | | | | | 6.4 |

### Bend Conditioning:

A 100×100 mm fabric/ceramic sample was placed halfway over the edge of a laboratory bench with a board, parallel to the benchtop edge, on top of the sample, leaving half of the sample unconstrained in space. The free half of the sample was bent downwards in the center of the sample at approximately a 45-degree angle, creating a crack in the dried ceramic, but not breaking the fabric. The sample was unambiguously compromised down this center crack.

### Flexural Conditioning:

A 100×100 mm fabric/ceramic sample was flexed around a 6-inch diameter cylinder as follows:
1) With one set of opposite edges of the 100×100 mm square parallel to the axis of the cylinder, the sample was flexed in one direction around the cylinder (flexed out of one plane), with the sample assuming a smooth, tight curvature around the cylinder.
2) The sample was then placed on the opposite side of the cylinder so it could be flexed in the opposite direction.
3) Steps 1) and 2) were repeated 9 times, for a total of 10 flexes in each direction.

This simulates processing of the dried material in a manufacturing line, going around multiple rolls, or potential handling in a manufacturing operation. After the first flex, the flexing was easier, indicating breaking or loosening of parts of the ceramic material, and/or loosening of the ceramic from the fabric.

### Pyrotechnic Blast Test:

The Pyrotechnic Blast Test (also referred to as a pyrotechnic withstand test) includes mounting a cloth and/or ceramic sample on an aluminum plate that is held fixed at 30 mm above the top of a pyrotechnic gerb, which was ignited, thereby creating a blast. The pyrotechnic charge in a generic gerb composition comprises potassium nitrate, potassium benzoate, sulfur, and titanium. These constituents are mixed, then hydraulically pressed into a convolute paper tube. A clay nozzle is pressed into the tube against the pyrotechnic charge. Gerbs may be ignited in a variety of ways, typically from an electronically generated pulse for precision timing. The ignited charge creates a blast of burning particles and hot gasses that shoot through the nozzle.

The Pyrotechnic Test was recorded on video at 30 frames per second. Before the end of the 20 second duration of the pyrotechnic gerb, the blast from the pyrotechnic gerb compromised the cloth/ceramic construction, then the aluminum plate. The Pyrotechnic Test recording was analyzed on video editing software to determine the time the gerb blast was first initiated and the time the gerb blast was observed blasting through the aluminum plate. The total time the Example with aluminum plate withstood the blast was calculated by subtracting the time the blast was first initiated from the time the blast was observed blasting through the aluminum plate. This difference was rounded to the nearest tenth of a second. The time required to blast through an aluminum plate with no ceramic or cloth on it was 0.80 seconds with a standard deviation of 0.08 seconds (n=4). All results presented below are the total time required to blast through the sample with aluminum plate minus the 0.8 seconds required to blast through the aluminum plate. For instance, if the sample with aluminum plate survived 9.8 seconds before breaking through the backside of the aluminum plate, the Pyrotechnic Withstand Time for the sample is 9.8-0.8=9.0 seconds. To calculate the efficiency or relative performance (Pyrotechnic Withstand Efficiency) of one construction with another that is at a different thickness, this Pyrotechnic Withstand Time may be divided by the thickness of the tested construction. This Pyrotechnic Withstand Efficiency result is expressed in seconds per millimeter, with higher values representing a material that is more effective or efficient at resisting the blast.

### EXAMPLES

### Comparative Example 1 (CE1)

Kasil 6 was coated onto a layer of TG430 with a #30 Meyer Bar, and another layer of TG430 was immediately laid on top of the Kasil 6 layer. This construction was dried in a 120 °C oven. This construction is quite flexible—it is able to wrap around a 6-inch diameter cylinder with relatively little force. Two 100×100 mm samples were cut from this construction, mounted onto 100×100 mm aluminum plates with 91022 transfer adhesive and tested in the Pyrotechnic Test. One sample survived 2.8 seconds before failure, and the other survived 1.2 seconds before failure from the blast.

### Comparative Example 2 (CE2)

Kasil 6 was coated onto a layer of TG430 with a #30 Meyer Bar, and another layer of TG430 was immediately laid on top of the Kasil 6 layer. This was repeated two more times to produce 4 layers of TG430 bonded together with 3 thin layers of Kasil 6. This construction was dried in a 120 °C oven. This construction is quite flexible—it is able to wrap around a 6-inch diameter cylinder with relatively little force. Two 100×100 mm samples were cut from this construction, mounted onto 100×100 mm aluminum plates with 91022 transfer adhesive and tested in the Pyrotechnic Test. One sample survived 3.5 seconds before failure, and the other survived 4.3 seconds before failure from the blast.

### Comparative Example 3 (CE3)

Kasil 6 was coated onto a layer of SC2025 with a #30 Meyer Bar, and another layer of SC2025 was immediately laid on top of the Kasil 6 layer. This construction was dried in a 120 °C oven. This construction is quite flexible—it is able to wrap around a 6-inch diameter cylinder with relatively little force. Two 100×100 mm samples were cut from this construction, mounted onto 100×100 mm aluminum plates with 91022 transfer adhesive and tested in the Pyrotechnic Test. Both samples survived 1.8 seconds before failure from the blast.

### Comparative Example 4 (CE4)

Ceramic Formulation B was coated onto two 100×100 mm aluminum plates and dried first at 100 °C, then at 120 °C. After drying at 100 °C, the brittle coatings had each cracked into 5 separate, randomly shaped pieces, and the pieces were warped/non-planar. After drying at 120 °C, this brittle coating had further cracked into more pieces, about 7-8 pieces each, and they were even more warped. The thickness of this dried coating was 0.79 mm. In order to subject this composition to the Pyrotechnic Test, the 91022 adhesive was placed on two new 100×100 mm aluminum plates, the individual pieces were carefully placed onto the adhesive, a flat plate was placed on top of this assemblage, then the plate was pressed down to force the slightly warped pieces to adhere to the adhesive. The coating did create more breaks in this process, but the pieces were well-bonded to the adhesive, and there were areas large enough with no breaks that the Pyrotechnic Test gerb could be positioned to blast in an unbroken area. One sample survived 7.8 seconds before failure, and the other survived 4.5 seconds before failure from the blast. Although this ceramic construction can provide good Pyrotechnic Test survivability, because of its brittleness, it cannot be processed in a continuous process easily, or be handled to any appreciable extent, without fracturing.

### Comparative Example 5 (CE5)

Ceramic Formulation B was coated onto a layer of SC2025 and dried at 120 °C. Two 100×100 samples were cut from this coating and subjected to the Bend Conditioning. During the Bend Conditioning, the samples cracked in numerous places, and pieces of the ceramic cracked off of the SC2025 fabric in many places. Although this two-layer construction results in a more planar construction than CE 4, it is more difficult to process in a roll-to-roll manufacturing process and may not be handled easily in a continuous manner without compromising its properties.

### Comparative Example 6 (CE6)

304 stainless steel, 0.75 mm thick, was cut into three 100×100 mm squares and each square was subjected to the Pyrotechnic Test. Only the steel plates were Pyrotechnic Tested (no aluminum plate, no adhesive). One sample survived 2.5 seconds and the other two samples survived 1.3 seconds each.

### Comparative Example 7 (CE7)

304 stainless steel, 1.61 mm thick, was cut into three 100×100 mm squares and each square was subjected to the Pyrotechnic Test. Only the steel plates were Pyrotechnic Tested (no aluminum plate, no adhesive). One sample survived 5.5 seconds and the other two samples survived 5.3 seconds each.

### Comparative Example 8 (CE8)

304 stainless steel, 2.24 mm thick, was cut into three 100×100 mm squares and each square was subjected to the Pyrotechnic Test. Only the steel plates were Pyrotechnic Tested (no aluminum plate, no adhesive). One sample survived 11.6 seconds, one sample survived 8.9 seconds, and one sample survived 9.0 seconds.

TABLE 3
Pyrotechnic Test results for Comparative Examples 1-4.

| | | | | | Pyrotechnic | |
|---|---|---|---|---|---|---|
| | | | Total | Basis | Withstand* | |
| | | | Thickness | Weight | Time | Efficiency |
| Example | Composition | n | (mm) | (g/sqm) | (s) | (s/mm) |
| CE 1 | 2 layers TG430 bonded with Kasil 6 | 2 | 0.72 | 887 | 2.0 | 2.8 |
| CE 2 | 4 layers TG430 bonded with Kasil 6 | 2 | 1.47 | 1830 | 3.9 | 2.7 |
| CE 3 | 2 layers SC2025 bonded with Kasil 6 | 2 | 1.64 | 1430 | 1.8 | 1.1 |
| CE 4 | Ceramic Formulation B | 2 | 0.79 | 1690 | 6.2 | 7.8 |
| CE 6 | 304 Stainless Steel | 3 | 0.75 | 5950 | 1.7 | 2.3 |
| CE 7 | 304 Stainless Steel | 3 | 1.61 | 12650 | 5.4 | 3.4 |
| CE 8 | 304 Stainless Steel | 3 | 2.24 | 17870 | 9.8 | 4.4 |

*Pyrotechnic Withstand Time is the time the total construction with aluminum plate withstood the blast, minus the time that the aluminum plate survives by itself (0.8 seconds). Pyrotechnic Withstand Efficiency is the Pyrotechnic Withstand Time divided by the construction thickness.

### Example 1

Ceramic Formulation A was coated between SC2025 and 1162 cloth layers and dried in a 120 °C oven, producing a construction with a thickness of 1.53 mm and a basis weight of 2520 grams/square meter. Two 100×100 mm samples were cut from this construction, mounted onto 100×100 mm aluminum plates with 91022 transfer adhesive (SC2025 side against the adhesive) and tested, as is, in the Pyrotechnic Test. One sample survived 9.8 seconds before failure, and the other survived 11.1 seconds before failure from the blast.

### Example 2

Ceramic Formulation A was coated between SC2025 and 1162 cloth layers and dried in a 120 °C oven, producing a construction with a thickness of 1.49 mm and a basis weight of 2470 grams/square meter. One 100×100 mm sample was cut from this construction, mounted onto a 100×100 mm aluminum plate with 91022 transfer adhesive (1162 side against the adhesive) and tested, as is, in the Pyrotechnic Test. This sample survived 9.4 seconds before failure from the blast.

### Example 3

Ceramic Formulation A was coated between SC2025 and 1162 cloth layers and dried in a 120 °C oven, producing a construction with a thickness of 1.50 mm and a basis weight of 2470 grams/square meter. One 100×100 mm sample was cut from this construction and subjected to the Bend Conditioning. This cracked construction was mounted onto a 100×100 mm aluminum plate with 91022 transfer adhesive (1162 side against the adhesive) and tested in the Pyrotechnic Test with the gerb blasting into the center of the cracked portion of the construction. This sample survived 10.6 seconds before failure from the blast.

### Example 4

Ceramic Formulation B was coated between two layers of TG430 cloth and dried in a 120 °C oven, producing a construction with a thickness of 1.28 mm and a basis weight of 2300 grams/square meter. Two 100×100 mm samples were cut from this construction, mounted onto 100×100 mm aluminum plates with 91022 transfer adhesive and tested, as is, in the Pyrotechnic Test. One sample survived 10.5 seconds before failure, and the other survived 8.5 seconds before failure from the blast.

### Example 5

Ceramic Formulation B was coated between two layers of TG430 cloth and dried in a 120 °C oven, producing a construction with a thickness of 1.28 mm and a basis weight of 2300 grams/square meter. Two 100×100 mm samples were cut from this construction. Each of these samples were subjected to Flexural Conditioning. These flexed samples were mounted onto 100×100 mm aluminum plates with 91022 transfer adhesive and tested in the Pyrotechnic Test. One sample survived 9.9 seconds before failure, and the other survived 9.7 seconds before failure from the blast.

### Example 6

Ceramic Formulation A was coated between SC2025 and 1162 cloth layers and dried in a 120 °C oven, producing a construction with a thickness of 1.22 mm and a basis weight of 1890 grams/square meter. Two 100×100 mm samples were cut from this construction, mounted onto 100×100 mm aluminum plates with 91022 transfer adhesive (1162 side against the adhesive) and tested, as is, in the Pyrotechnic Test. These samples survived an average of 7.1 seconds before failure from the blast.

### Example 7

Ceramic Formulation A was coated between SC2025 and 1162 cloth layers and dried in a 120 °C oven, producing a construction with a thickness of 1.72 mm and a basis weight of 2890 grams/square meter. Two 100×100 mm samples were cut from this construction, mounted onto 100×100 mm aluminum plates with 91022 transfer adhesive (1162 side against the adhesive) and tested, as is, in the Pyrotechnic Test. These samples survived an average of 14.6 seconds before failure from the blast.

### Example 8

Ceramic Formulation A was coated between 1162 and 1597 cloth layers and dried in a 120 °C oven, producing a construction with a thickness of 1.84 mm and a basis weight of 3010 grams/square meter. Two 100×100 mm samples were cut from this construction, mounted onto 100×100 mm aluminum plates with 91022 transfer adhesive (1162 side against the adhesive) and tested, as is, in the Pyrotechnic Test. One sample survived 14.9 seconds before failure, and the other survived 13.9 seconds before failure from the blast.

### Example 9

Ceramic Formulation A was coated between two layers of 1162 cloth and dried in a 120 °C oven, producing a construction with a thickness of 0.59 mm and a basis weight of 1030 grams/square meter. Two 100×100 mm samples were cut from this construction, mounted onto 100×100 mm aluminum plates with 91022 transfer adhesive and tested, as is, in the Pyrotechnic Test. One sample survived 2.7 seconds before failure, and the other survived 2.9 seconds before failure from the blast.

### Example 10

Ceramic Formulation C was coated between PW-200-13-100 and PW-350-13-100 cloth layers and dried in a 120 °C oven, producing a construction with a thickness of 1.49 mm and a basis weight of 1820 grams/square meter. Two 100×100 mm samples were cut from this construction, mounted onto 100×100 mm aluminum plates with 91022 transfer adhesive (PW-200-13-100 side against the adhesive) and tested, as is, in the Pyrotechnic Test. One sample survived 10.4 seconds before failure, and the other survived 7.7 seconds before failure from the blast.

### Example 11

Ceramic Formulation D was coated between two layers of TG430 cloth and dried in a 120 °C oven, producing a construction with a thickness of 1.03 mm and a basis weight of 1650 grams/square meter. Two 100×100 mm samples were cut from this construction, mounted onto 100×100 mm aluminum plates with 91022 transfer adhesive and tested, as is, in the Pyrotechnic Test. One sample survived 7.7 seconds before failure, and the other survived 9.1 seconds before failure from the blast.

### Example 12

Ceramic Formulation D was coated between two layers of TG430 cloth and dried in a 120 °C oven, producing a construction with a thickness of 1.02 mm and a basis weight of 1650 grams/square meter. Two 100×100 mm samples were cut from this construction and subjected to the Bend Conditioning. These cracked constructions were mounted onto a 100×100 mm aluminum plate with 91022 transfer adhesive and tested in the Pyrotechnic Test with the gerb blasting into the center of the cracked portion of the construction. One sample survived 8.2 seconds before failure, and the other survived 7.3 seconds before failure from the blast.

### Example 13

Ceramic Formulation E was coated between SC2025 and TG430 cloth layers and dried in a 120 °C oven, producing a construction with a thickness of 1.56 mm and a basis weight of 2210 grams/square meter. Two 100×100 mm samples were cut from this construction, mounted onto 100×100 mm aluminum plates with 91022 transfer adhesive (SC2025 side against the adhesive) and tested, as is, in the Pyrotechnic Test. One sample survived 4.8 seconds before failure, and the other survived 4.7 seconds before failure from the blast.

### Example 14

Ceramic Formulation E was coated between SC2025 and TG430 cloth layers and dried in a 120 °C oven, producing a construction with a thickness of 1.56 mm and a basis weight of 2240 grams/square meter. Two 100×100 mm samples were cut from this construction and subjected to Flexural Conditioning. These cracked constructions were mounted onto a 100×100 mm aluminum plate with 91022 transfer adhesive (SC2025 side against the adhesive) and tested in the Pyrotechnic Test with the gerb blasting into the center of the construction. One sample survived 4.6 seconds before failure, and the other survived 4.5 seconds before failure from the blast.

### Example 15

Ceramic Formulation F was coated between two layers of TG430 and dried in a 120 °C oven, producing a construction with a thickness of 1.19 mm and a basis weight of 1860 grams/square meter. Two 100×100 mm samples were cut from this construction, mounted onto 100×100 mm aluminum plates with 91022 transfer adhesive and tested, as is, in the Pyrotechnic Test. One sample survived 5.0 seconds before failure, and the other survived 6.1 seconds before failure from the blast.

### Example 16

Ceramic Formulation F was coated between two layers of TG430 and dried in a 120 °C oven, producing a construction with a thickness of 1.10 mm and a basis weight of 1750 grams/square meter. Two 100×100 mm samples were cut from this construction and subjected to Flexural Conditioning. These cracked constructions were mounted onto a 100×100 mm aluminum plate with 91022 transfer adhesive and tested in the Pyrotechnic Test with the gerb blasting into the center of the construction. One sample survived 5.0 seconds before failure, and the other survived 5.1 seconds before failure from the blast.

### Example 17

Ceramic Formulation G was coated between two layers of TG430 and dried in a 120 °C oven, producing a construction with a thickness of 1.24 mm and a basis weight of 1730 grams/square meter. Two 100×100 mm samples were cut from this construction, mounted onto 100×100 mm aluminum plates with 91022 transfer adhesive and tested, as is, in the Pyrotechnic Test. One sample survived 3.7 seconds before failure, and the other survived 4.5 seconds before failure from the blast.

### Example 18

Ceramic Formulation G was coated between two layers of TG430 and dried in a 120 °C oven, producing a construction with a thickness of 1.27 mm and a basis weight of 1710 grams/square meter. Two 100×100 mm samples were cut from this construction and subjected to the Bend Conditioning. These cracked constructions were mounted onto a 100×100 mm aluminum plate with 91022 transfer adhesive and tested in the Pyrotechnic Test with the gerb blasting into the center of the cracked portion of the construction. One sample survived 4.3 seconds before failure, and the other survived 4.0 seconds before failure from the blast.

TABLE 4
Pyrotechnic Test results for Examples 1-18.

| | Lower | | Upper | | | | | Pyrotechnic | |
|---|---|---|---|---|---|---|---|---|---|
| | Glass | | Glass | | | Total | Basis | Withstand | |
| | Cloth | Ceramic | Cloth | | | Thickness | Weight | Time | Efficiency |
| Example | Layer | Form. | Layer | Conditioning | n | (mm) | (g/sqm) | (s) | (s/mm) |
| Ex. 1 | SC2025 | A | 1162 | None | 2 | 1.53 | 2,520 | 10.5 | 6.8 |
| Ex. 2 | 1162 | A | SC2025 | None | 1 | 1.49 | 2,470 | 9.4 | 6.3 |
| Ex. 3 | 1162 | A | SC2025 | Bend | 1 | 1.50 | 2,470 | 10.6 | 7.1 |
| Ex. 4 | TG430 | B | TG430 | None | 2 | 1.28 | 2,300 | 9.5 | 7.4 |
| Ex. 5 | TG430 | B | TG430 | Flex | 2 | 1.28 | 2,300 | 9.8 | 7.6 |
| Ex. 6 | 1162 | A | SC2025 | None | 2 | 1.22 | 1,890 | 7.1 | 5.8 |
| Ex. 7 | 1162 | A | SC2025 | None | 2 | 1.72 | 2,890 | 14.6 | 8.5 |
| Ex. 8 | 1162 | A | 1597 | None | 2 | 1.84 | 3,010 | 14.4 | 7.8 |
| Ex. 9 | 1162 | A | 1162 | None | 2 | 0.59 | 1,030 | 2.8 | 4.7 |
| Ex. 10 | PW-200 | C | PW-350 | None | 2 | 1.49 | 1,820 | 9.1 | 6.1 |
| Ex. 11 | TG430 | D | TG430 | None | 2 | 1.03 | 1,650 | 8.4 | 8.2 |
| Ex. 12 | TG430 | D | TG430 | Bend | 2 | 1.02 | 1,650 | 7.8 | 7.6 |
| Ex. 13 | SC2025 | E | TG430 | None | 2 | 1.56 | 2,210 | 4.8 | 3.1 |
| Ex. 14 | SC2025 | E | TG430 | Flex | 2 | 1.56 | 2,240 | 4.6 | 2.9 |
| Ex. 15 | TG430 | F | TG430 | None | 2 | 1.19 | 1,860 | 5.6 | 4.7 |
| Ex. 16 | TG430 | F | TG430 | Flex | 2 | 1.1 | 1,750 | 5.1 | 4.6 |
| Ex. 17 | TG430 | G | TG430 | None | 2 | 1.24 | 1,730 | 4.1 | 3.3 |
| Ex. 18 | TG430 | G | TG430 | Bend | 2 | 1.27 | 1,710 | 4.2 | 3.3 |

Example 1 gives an indication of the variance in this test, showing moderate variability from specimen to specimen (also note that the simpler Comparative Examples also had variability). Example 2, with the uncompromised ceramic, survived 9.4 seconds. Example 3, with the fractured ceramic in the center of the blast, survived 10.6 seconds. Example 3, with the fractured ceramic sandwiched between fabric layers, performed better than the uncompromised Example 2, though based on the variability of this test, Example 3 is likely similar in performance to Example 2. This demonstrates the synergy of sandwiching the ceramic layer between layers of fabric.

In addition, the constructions comprising ceramic sandwiched between fabric layers showed improved pyrotechnic withstand performance as compared to the stainless steel comparative samples. For example, the Pyrotechnic Withstand Efficiency of the sandwiched constructions of Examples 1-3 is about twice that of a 304 stainless steel comparative sample at a similar thickness (CE 7).

As total construction weight is extremely important in electric vehicle performance, an assessment of the Pyrotechnic Withstand of these constructions on a weight basis, rather than a thickness basis, was performed. The density (basis weight divided by thickness) of 304 stainless steel is around 7.9 g/cm³ while the density of, for example, Examples 1-3 is around 1.7 g/cm³. The Pyrotechnic Withstand value (based on time) for the constructions of Examples 1-3 is approximately twice that as compared to the 304 stainless steel examples. Thus, as a function of weight (assuming the same thicknesses for ceramic/fabric constructions and the stainless steel examples) the ceramic/fabric constructions described herein have a Pyrotechnic Withstand performance about nine times better than the stainless steel comparative examples. In other words, for a given pyrotechnic blast resistance, a stainless steel thermal barrier article would be about nine times heavier than a ceramic/fabric thermal barrier article (as described herein) of similar thickness.

The two samples of Example 4, with no bending or flexing, survived an average of 9.5 seconds. The two samples of Example 5, with the same composition as Example 4 but having been subjected to the Flexural Conditioning, survived an average of 9.8 seconds, demonstrating that the synergism in disposing the ceramic layer between fabric layers. This construction enhances both manufacturability and usability.

In addition, even though these Examples contain two layers with a relatively low Pyrotechnic Test Efficiency and only one layer with a relatively high Pyrotechnic Test Efficiency, the overall Pyrotechnic Test Efficiency of these constructions is close to that of a ceramic by itself (a high Pyrotechnic Test Efficiency). CE 4, the ceramic only comparative example, has a Pyrotechnic Test Efficiency of 7.8, while Examples 4 and 5 have Pyrotechnic Test Efficiencies of 7.4 and 7.6, nearly that of CE 4. This is despite the fact that there is actually less ceramic in Examples 4 and 5, as evidenced by both the overall thicknesses and basis weights. The thickness of the Examples 4 and 5 ceramic can be estimated from the thickness of the overall construction minus the thickness of the two TG430 layers: 1.28-2× (0.38)=0.52 mm. The total thickness of CE4 (0.79 mm) is greater than that of Examples 4 and 5. There is some bleedthrough of the ceramic into the TG430. To address any bleedthrough of the ceramic into the TG430, subtract the basis weight of the TG430 cloth from the total basis weights of Examples 4 and 5: 2300-2×430=1440 g/sqm. This is less than the 1690 g/sqm of CE 4. Therefore, the layered inorganic cloth/ceramic/inorganic cloth constructions have a synergistic effect related to blast performance.

Examples 7 and 8 demonstrate thicker and heavier constructions made for surviving extremely high energy battery blasts. Even thicker constructions could also be employed, depending on the specific application.

Example 9 demonstrates that a very thin layer of ceramic (approximately 0.31 mm) can be formed between layers of glass cloth. This construction can be easily bent and flexed while still providing blast resistance, and it can also be easily made in a continuous manufacturing process. A ceramic material only 0.31 mm thick, even if lightly flexed over larger 25 cm diameter (or larger) rolls in a manufacturing process, would not be able to withstand the tensile forces required to pull it through such a process. Different battery systems and pack constructions require different types of blast protection. There is quite a wide range of blast protection required for different sizes and form factors of higher energy density batteries, and different pack constructions (e.g. different backing plates and/or different distances between the battery vent port and the blast material) will also require different thicknesses for optimizing weight, thickness, blast protection, etc. The ability to process a construction with a thinner ceramic for battery applications requiring lower blast performance than others is useful.

Example 10 demonstrates the use of a blend of different types of filler, as well use of an inorganic cloth made from basalt fibers, and a ceramic composition with 24 weight percent binder and 76 weight percent filler (on a dry basis).

Examples 11 and 12 illustrate a ceramic composition comprising a blend of two different binders, sodium silicate and potassium silicate. Similar to Examples 2 and 3, Examples 11 and 12 further demonstrate that the ceramic middle layer of an inorganic cloth/ceramic/inorganic cloth construction can be bent and cracked, yet still survive a Pyrotechnic Test with very little effect on its blast performance.

Examples 13 and 14 show the use of a ceramic composition with a blend of two different fillers. The flake-like boron nitride filler demonstrates anisotropic, high thermal conductivity, with very high thermal conductivity in the planar direction. The planar-oriented boron nitride flake can provide heat dissipation in the ceramic's planar direction because the planar boron nitride flakes will preferentially orient in-plane in a coating process, particularly at high flake concentrations.

Comparing the blast resistance of Examples 13 and 14 demonstrates that inorganic cloth/ceramic/inorganic cloth compositions can be flexed without loss of blast resistance.

Examples 15 and 16 exhibit a ceramic composition with a high concentration of the binder and three different fillers. After drying, the binder concentration is 61.3 weight percent sodium silicate, and the inorganic fiber is 0.4 weight percent.

Comparing the blast resistance of Examples 15 and 16 demonstrates that inorganic cloth/ceramic/inorganic cloth compositions can be flexed without significant loss of blast resistance.

Examples 17 and 18 illustrate a ceramic composition having a relatively high fiber concentration; after drying the ceramic, the fiber concentration is 6.4 weight percent. Comparing the blast resistance of Examples 17 and 18 demonstrates that inorganic cloth/ceramic/inorganic cloth compositions can be bent and cracked without significant loss of blast resistance.

To address variation in the data for samples which were blast tested As-Is vs samples which were subjected to either the Bend Conditioning or the Flexural Conditioning, samples within each compositional group were compared with one another. For instance, the average Pyrotechnic Withstand of the four constructions of Examples 17 and 18 (4.125 seconds) was subtracted from each of the individual values of the four constructions of Examples 17 and 18, yielding −0.43 and +0.38 seconds from the average for the two Example 17 constructions (tested As-Is), and +0.18 and −0.13 seconds from the average for the two Example 18 constructions (Bend Conditioning). These departures from the average are shown in Table 5 for all pairs of constructions tested As-Is and either Bent or Flexed.

Table 5 provides the time difference from the average within each composition for pairs of samples tested As-Is vs samples that were either bent or flexed. The average value of each of the compositional groups of values in Table 5 will be zero (to within rounding error of the number of displayed significant figures).

TABLE 5

| | Lower | | Upper | | Time Difference | |
|---|---|---|---|---|---|---|
| | Glass | | Glass | | from Average (s) | |
| | Cloth | Ceramic | Cloth | | | Bent or |
| Examples | Layer | Form. | Layer | Conditioning | As-Is | Flexed |
| 2 and 3 | 1162 | A | SC2025 | Bend | −0.60 | 0.60 |
| 4 and 5 | TG430 | B | TG430 | Flex | 0.85 | 0.25 |
| | | | | | −1.15 | 0.05 |
| 11 and 12 | TG430 | D | TG430 | Bend | −0.37 | 0.13 |
| | | | | | 1.03 | −0.77 |
| 13 and 14 | SC2025 | E | TG430 | Flex | 0.15 | −0.05 |
| | | | | | 0.05 | −0.15 |
| 15 and 16 | TG430 | F | TG430 | Flex | −0.30 | −0.30 |
| | | | | | 0.80 | −0.20 |
| 17 and 18 | TG430 | G | TG430 | Bend | −0.43 | 0.18 |
| | | | | | 0.38 | −0.13 |
| | | | | Average | 0.04 | −0.04 |
| | | | | St. Dev. | 0.68 | 0.35 |

Comparing the data set of all eleven not-bent, not-flexed constructions with the data set of all eleven bent or flexed constructions shows that both data sets are statistically equivalent. The largest departures from average, both on the positive and negative side, are, surprisingly, in the not-bent, not-flexed constructions, at −1.15 seconds and +1.03 seconds. The average value for the eleven not-bent, not-flexed constructions is +0.04 seconds, with a standard deviation of 0.68 seconds. The average value for the eleven bent or flexed constructions is −0.04 seconds with a standard deviation of 0.35 seconds. Although the average value of the eleven bent or flexed constructions is slightly less than that of the eleven not-bent, not-flexed constructions, the standard deviations of the two data sets are about an order of magnitude or more greater than these average values. This strongly suggests that the average value of the not-bent, not-flexed data set is essentially the same as the average value of bent or flexed constructions. A 2-Sample t-Test comparing these two data sets shows them to be statistically identical: the p-value for this 2-Sample t-Test is 0.76. A p-value of greater than about 0.05 between two data sets suggests the data sets have the same average or mean. Because 0.76 is so much greater than 0.05, we can confidently state that the combined bent and flexed data are statistically the same as the not-bent, not-flexed constructions, i.e., flexing and bending does not change its blast resistance.

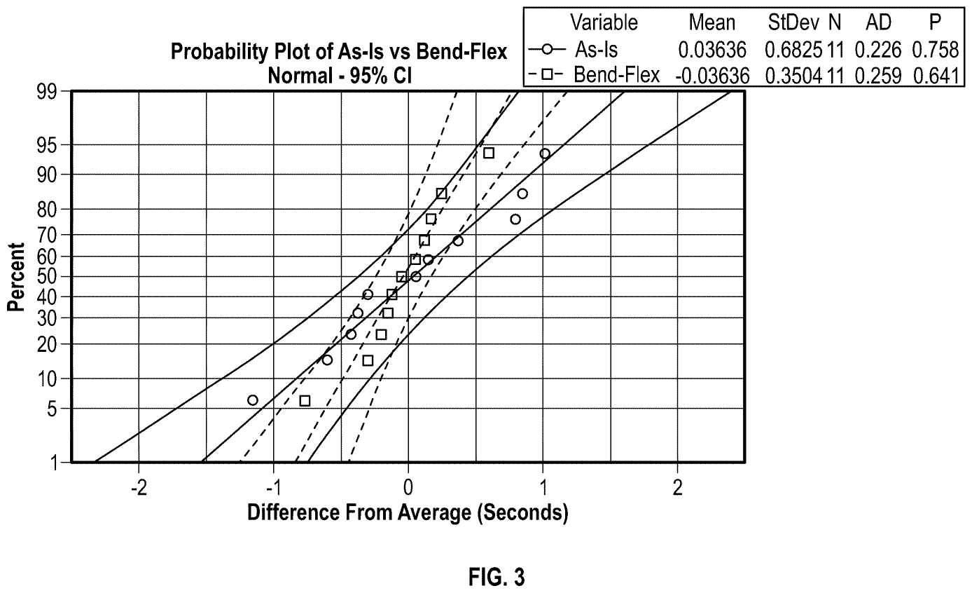

In addition, plotting each of these two data sets in a normal distribution probability plot (FIG. 3) shows each of these data sets to have a normal distribution: the p-value for the eleven not-bent, not-flexed constructions is 0.76, and the p-value for the eleven bent or flexed constructions is 0.64. Because these p-values are so much greater than 0.05, these data sets follow a normal distribution, confirming that use of the 2-Sample t-test to compare the two data sets is valid.

Each of the compositional groups that were tested both As-Is and either Bent or Flexed (e.g. Examples 2 and 3, 4 and 5, or 11 and 12) is made with a different ceramic composition, different thickness, and different layers of inorganic cloth. To compensate for these differences, the same analysis can be made by normalizing each of the compositional groups to a percent change from the average. For instance, the percent change from the average of Examples 17 and 18 becomes −10.3% and +9.1% from the average for the two Example 17 constructions, and 4.2% and −3.0% from the average for the two Example 18 constructions (Table 6). The p-value for this 2-Sample t-Test is 0.52 (much greater than 0.05), so both data sets are statistically identical. Plotting the two data sets in a probability plot shows both to follow a normal distribution: the p-value for the eleven not-bent, not-flexed constructions is 0.50, and the p-value for the eleven bent or flexed constructions is 0.96, confirming that the 2-Sample t-Test results affirm that there is statistically no difference between the not-bent, not-flexed constructions and the constructions that were bent or flexed.

Table 6 shows the percent difference from the average within each composition for pairs of samples tested As-Is vs samples that were either bent or flexed. The average value of each of the compositional groups of values will be zero (to within rounding error of the number of displayed significant figures).

TABLE 6

| | | | | | Percent | |
|---|---|---|---|---|---|---|
| | | | | | Difference | |
| | Lower | | Upper | | from | |
| | Glass | | Glass | | Average (%) | |
| | Cloth | Ceramic | Cloth | | | Bent or |
| Examples | Layer | Form. | Layer | Conditioning | As-Is | Flexed |
| 2 and 3 | 1162 | A | SC2025 | Bend | −6.0 | 6.0 |
| 4 and 5 | TG430 | B | TG430 | Flex | 8.8 | 2.6 |
| | | | | | −11.9 | 0.5 |
| 11 and 12 | TG430 | D | TG430 | Bend | −4.6 | 1.5 |
| | | | | | 12.7 | −9.6 |
| 13 and 14 | SC2025 | E | TG430 | Flex | 3.2 | −1.1 |
| | | | | | 1.1 | −3.2 |
| 15 and 16 | TG430 | F | TG430 | Flex | −5.7 | −5.7 |
| | | | | | 15.1 | −3.8 |
| 17 and 18 | TG430 | G | TG430 | Bend | −10.3 | 4.2 |
| | | | | | 9.1 | −3.0 |
| | | | | Average | 1.0 | −1.0 |
| | | | | St. Dev. | 9.4 | 4.6 |

These examples demonstrate that placing a ceramic or ceramic-like material between layers of glass cloth has unexpected synergistic properties and provide a construction that is both manufacturing-friendly and easily handled by a user. These constructions can be processed in a continuous manufacturing process, and can be bent or flexed with no detrimental effects on blast performance. A wide range of inorganic cloth constructions can be utilized in these constructions. The binder can comprise a single composition or a blend of two or more binders. The filler can comprise a single inorganic material or a blend of different materials. The filler shapes can be spherical, platelike, fiber-like, and/or amorphous. The thicknesses of the fabric and of the ceramic can have a wide range, depending on the specific application.

All cited references, patents, and patent applications in the above application for letters patent are herein incorporated by reference in their entirety in a consistent manner. In the event of inconsistencies or contradictions between portions of the incorporated references and this application, the information in the preceding description shall control. The preceding description, given in order to enable one of ordinary skill in the art to practice the claimed disclosure, is not to be construed as limiting the scope of the disclosure, which is defined by the claims and all equivalents thereto.

1. A thermal barrier article comprising a multilayer material, wherein the multilayer material includes a first fabric layer, a second fabric layer and at least one ceramic layer, wherein the at least one ceramic layer comprises a first ceramic layer that includes an inorganic filler and an inorganic binder, wherein the first fabric layer is disposed on a first side of the first ceramic layer and a second fabric layer is disposed on an opposite side of the first ceramic layer, wherein thermal barrier article has sufficient flexure to withstand a flexural conditioning test as defined herein and is capable of withstanding, for at least 2.5 seconds, a pyrotechnic blast test as defined herein that has a temperature of at least 1200 °C and expels a non-insubstantial amount of particulate.

2. The thermal barrier article of claim 1, wherein thermal barrier article has sufficient flexure to withstand a flexural conditioning test as defined herein and is capable of withstanding the pyrotechnic blast test for at least 6 seconds.

3. (canceled)

4. The thermal barrier article of claim 1, wherein the at least one fabric layer includes a woven or nonwoven fiber mat or fabric.

5-6. (canceled)

7. The thermal barrier article of claim 1, wherein the inorganic filler comprises a filler material selected from the group consisting of kaolin clay, metakaolin, talc, mica, mullite, phlogopite, muscovite, montmorillonite, smectite, bentonite, illite, chlorite, sepiolite, attapulgite, halloysite, vermiculite, laponite, rectorite, perlite, fly ash, fumed silica, silica fume, Portland cement, concrete mixes, and combinations thereof.

8. The thermal barrier article of claim 1, wherein the inorganic binder comprises an inorganic binder selected from the group consisting of sodium silicate, potassium silicate, lithium silicate, calcium silicate, colloidal silica, (poly)phosphate, (poly)boronite, (poly)aluminate, water, and combinations thereof.

9. (canceled)

10. The thermal barrier article of claim 1, wherein the fabric layers of the multilayer material are the same throughout the multilayer material in at least one of composition and thickness.

11. The thermal barrier article of claim 1, wherein the fabric layers of the multilayer material comprise different materials in some or all of the plurality of fabric layers and/or can be of different thicknesses.

12-13. (canceled)

14. The thermal barrier article of claim 1, wherein the at least one fabric layer comprises a woven or nonwoven fiber mat or fabric comprising a plurality of fibers selected from the group consisting of A-glass, C-glass, D-glass, E-glass, M-glass, R-glass, S-glass, ECR-glass, AR-glass, basalt fibers, silicate fibers, silicon carbide fibers, and ceramic fibers.

15. The thermal barrier article of claim 1, wherein the at least one fabric layer comprises ceramic or mineral compositions selected from basalt, alumina, aluminoborosilicate, Nextel, silicon carbide, quartz, and combinations thereof.

16. The thermal barrier article of claim 1, wherein at least one of the first and second fabric layers comprises a coating having an alkali-resistant composition.

17. The thermal barrier article of claim 16, wherein the alkali-resistant composition comprises calcium silicate.

18. The thermal barrier article of claim 1, comprising an adhesive layer applied to at least one outer surface of the first or second fabric layer.

19. The thermal barrier article of claim 18, wherein the adhesive layer comprises an adhesive selected from the group consisting of a thermoset, a hot melt, a pressure-sensitive adhesive, a solvent-born adhesive, and a water-born adhesive.

20. The thermal barrier article of claim 1, wherein the thermal barrier article has a thickness in the range of from about 0.5 mm to about 5.0 mm.

21-22. (canceled)

23. A battery compartment of an electric vehicle comprising at least one battery cell or assembly, wherein the thermal barrier article of claim 1 is disposed between the at least one battery cell or assembly and a lid.

24. A method of preventing or at least mitigating the further spread of blast debris in or from an electric vehicle battery assembly, with the method comprising:
at least partially enclosing at least one battery cell or module of an electric vehicle battery assembly with the thermal barrier article of claim 1.

25. Use of a barrier article as a thermal insulation and blast protection barrier in a rechargeable electrical energy storage system, the barrier article comprising the composition of the thermal barrier article of claim 1.

26. (canceled)
